(19) United States
(12) Patent Application Publication
(10) Pub. No.: US 2008/0053480 A1
(43) Pub. Date: Mar. 6, 2008

(54) Burr hog cleaning device

(76) Inventors: J. Dennis Hancock, Roanoke, VA (US); Shawn Kimmel, Springfield, VA (US)

Correspondence Address: SETO PATENTS, 406 RIVERLAND DR., SALEM, VA, 24153, US

(21) Appl. No.: 11/897,750

(22) Filed: Sep. 1, 2007

Related U.S. Application Data
(60) Provisional application No. 60/841,375, filed on Sep. 1, 2006.

(51) Int. Cl. B08B 3/00

(52) U.S. Cl. 134/6; 134/58 R

(57) ABSTRACT

An automated cleaning device for dental drill bits, also called dental burrs. The cleaning device includes an enclosed cleaning compartment that houses two rotating, circular brushes. The dental burr is guided through a small opening in the cleaning compartment and forced in between the two rotating brushes. The dental burr is rotated while between the brushes and moved in and out of the brushes during the cleaning process. A switch attached to the opening in the cleaning compartment allows the brushes to start rotating when a dental burr is inserted into the compartment, and stop when the burr is removed. The device includes an electric motor that can be powered by batteries or by plugging into a traditional electrical outlet.

The present invention was originally disclosed in U.S. provisional patent application No. 60/841,375 filed on Sep. 1, 2006, and priority is claimed to the provisional patent application.

### BACKGROUND

The present invention relates generally to the field of cleaning devices and more specifically to an automated cleaning device for dental burrs.

A dental burr is a small drill bit that is held in place at the terminal end of a dentist's drill. The dental burr is rotated at high speeds by the drill and is used for drilling into a tooth and also for removing filling material. Dental burrs are provided in different shapes and sizes depending on the purpose for which they will be used. Drilling burrs have a narrow profile while filing burrs have a much broader profile. All dental burrs include sharp edges, which do the actual drilling or filing, removal work. Some dental burrs are shaped like a standard drill bit with flutes, or grooves, between the cutting edges. Other burrs are covered by thousands of minute pieces of diamond that are attached in various ways. Both types of dental burrs have troughs in between the cutting edges that fill-up with un-wanted material during the drilling process. Enamel and other material from the tooth itself is usually fairly easy to clean off of the dental burr. However, filling materials and other man-made materials, including amalgam, resin and composites, tend to stick within the grooves of dental burrs and have proven to be extremely hard to remove. Traditional cleaning methods, such as chemical baths, ultra-sound, pressure washing and heating, have failed to effectively remove these materials from within the grooves of dental burrs. When a dental burr cannot have material from an old patient removed from it, i.e., the burr cannot be sanitized, a dentist can no longer use the burr and it must be thrown away. To make matters worse, dental burrs are made of metal and it is not uncommon to have rust form on the surface and in the grooves of burrs. Traditional cleaning methods have also proven unsuccessful in removing rust from within the grooves of dental burrs. Thus a dentist may not only have to throw away recently used dental burrs, because they cannot be sanitized, but the dentist may also have to throw away burrs that have just been sitting around unused, because rust has formed within the grooves of the burrs. This high turnover rate of dental burrs is inefficient both from a cost point of view and from an ecology point of view. If the dentists had an effective cleaning device that could remove un-wanted material from the grooves of dental burrs, they could clean and re-use their on-hand supply of dental burrs instead of throwing them away and buying new dental burrs. This would reduce the dentist's overall cost for dental burrs and it would reduce the amount of natural resources consumed in the production of new dental burrs, as the demand for new burrs would go down.

What is needed in the field is a dental burr cleaning device that is able to remove man-made materials and rust from between the cutting edges of dental burrs. The ideal cleaning device would be automated so that the burrs could be cleaned relatively quickly and without the need for a lot of manpower. The ideal device would also be able to be integrated into a series of cleaning processes that would produce sanitized dental burrs.

### SUMMARY OF THE INVENTION

A automated device that is adapted for cleaning dental drill bits, also known as dental burrs. The device comprises a cleaning compartment, a power compartment, a gear compartment, and an exterior shell. The cleaning compartment houses a first circular brush that is supported by a first axle, and a second circular brush that is supported by a second axle. Each axle is attached to its associated circular brush so that the brush rotates when the axle is rotated. The power compartment houses at least one electric motor and the drive shaft of the electric motor extends into the gear compartment. The power compartment includes a battery pack that supplies electrical power to the motor, and also includes a power cord for that is adapted to receive electrical power from a traditional wall outlet. The gear compartment houses a series of gears that transfers rotational force from the electric motor's drive shaft to the first and second axles, which in turn rotate the two brushes. The exterior shell houses the cleaning compartment, the power compartment and the gear compartment. The exterior shell includes a small opening that leads into the cleaning compartment. The opening is positioned so that any dental burr that enters the cleaning compartment is forced in between the two rotating brushes.

A debris tray is provided at the bottom of the cleaning compartment so that all debris that is scoured from the dental burr during cleaning falls on the debris tray. The debris tray can be removed from the device and emptied after each cleaning. An inspection assistance device, such as a magnifying glass, is attached to the exterior shell to assist the user in inspecting the drill bit after cleaning. The cleaning compartment of the device is effectively self contained, meaning that debris that is knocked off of the dental burr during cleaning is contained within the cleaning compartment and is not able to enter the gear compartment nor the power compartment.

The series of gears comprises four gears: a drive gear that is attached to the drive shaft; a first brush gear that is attached to the first axle; a second brush gear that is attached to the second axle; and, a reduction gear that is supported by a support axle. The drive gear engages with the reduction gear, the reduction gear engages with the second brush gear, and the second brush gear engages with the first brush gear. This arrangement causes the brushes to rotate in opposite directions which provides a slight pull on the cleaning rod, to the user, when a dental burr is placed between the brushes. The first brush gear and the second brush gear preferably have the same size. The brushes can have a variety of different bristles, including metal and man-made materials, and a variety of different widths.

It is an object of the present invention to provide an easy to use device for efficient and effective cleaning of dental burrs.

It is a further object of the present invention to provide a cleaning device with an self enclosed cleaning compartment that prevents debris from escaping.

It is yet another object of the present invention to provide an automated cleaning device that can be incorporated in sterilization process of dental burrs.

### BRIEF DESCRIPTION OF THE DRAWINGS

The invention of the present application will be described in detail with reference to the accompanying drawing(s), given only by way of example, in which:

FIG. 1 is a perspective view of the preferred embodiment;

FIG. 2 is a perspective view of the preferred embodiment with the front of the exterior shell removed;

FIG. 3 is a side view of the preferred embodiment with the side of the exterior shell removed showing the gearing system of the preferred embodiment;

FIG. 4 is a back perspective view of the preferred embodiment with the back of the exterior shell removed showing power compartment;

FIG. 5 is a flow chart showing exemplary steps for using the preferred embodiment; and,

FIG. 6 is a flow chart showing exemplary steps for cleaning and sanitizing dental burrs.

### DETAILED DESCRIPTION OF THE INVENTION

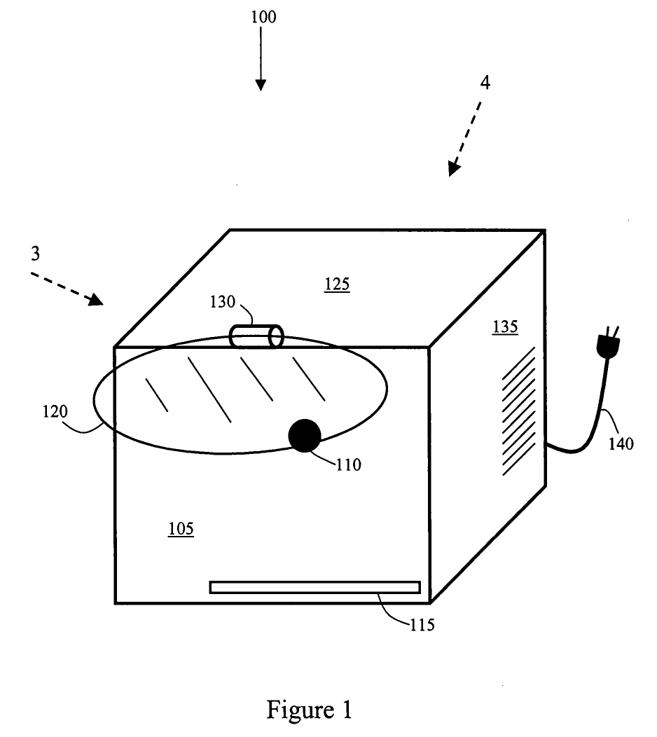

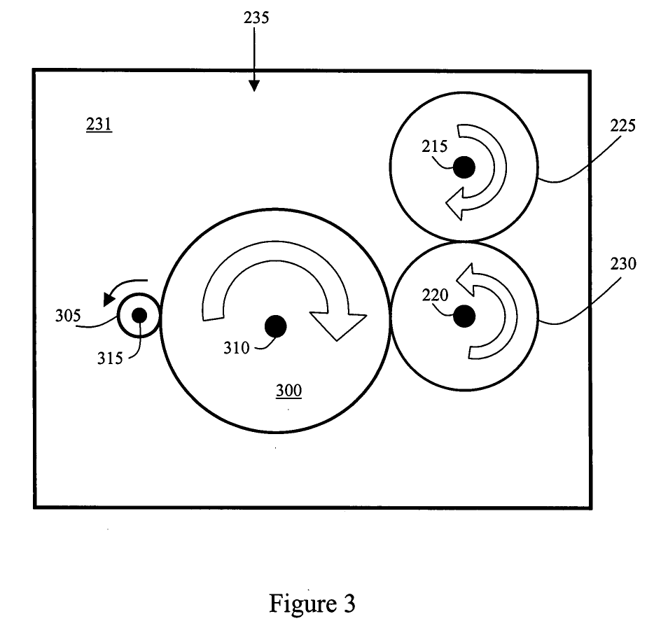

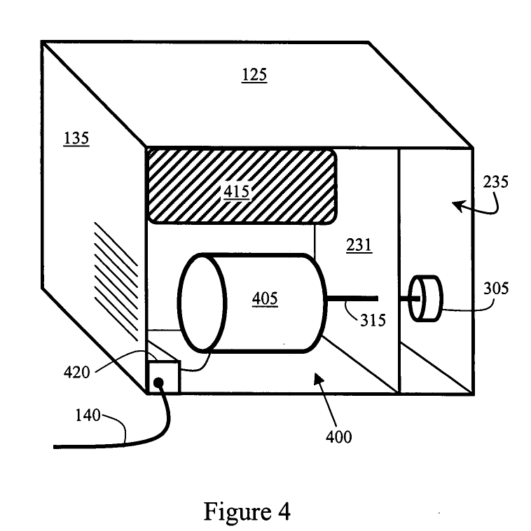

The present invention is an automated dental bit, or dental burr, cleaning device, referred to herein as the “Burr Hog”. FIG. 1 shows the preferred embodiment 100 of the present cleaning device wherein, all moving parts are contained within a housing, or exterior shell, which includes top 125, front panel 105 and right side 135. The front panel 105 of the shell includes a stretchable insertion hole 110 through which a dental burr is inserted for cleaning. Prior to insertion, the dental burr is attached to a holding device called a cleaning rod. Cleaning rods come in different sizes but all include an attachment mechanism, similar to that found at the end of a dental drill, for holding the dental burr. Other holding devices, however, may also be used. The stretchable hole 110 is intentionally smaller than the circumference of the dental burr and the cleaning rod so that a seal is created and debris does not fly out of the front of the Burr Hog 100 during operation. The preferred embodiment is activated automatically upon insertion of the dental burr, similar to the operation of an electric pencil sharpener. When the cleaning device is activated, a pair of circular brushes inside the device 100 begins to rotate. When the dental burr is removed from the cleaning device, the burr hog senses the removal and automatically shuts off, and the brushes stop rotating. At the bottom of the front panel 105 is an opening 115 that allows for insertion and removal of a sliding debris tray. Debris that is brushed off of dental burrs during the cleaning process eventually drops to the bottom of the device and gathers on the debris tray. The debris on the tray is disposed of by removing and cleaning the debris tray. The debris tray may optionally include a sticky surface layer that aids in the collection of debris and that can be peeled off and thrown away. When the debris tray is fully inserted in the front panel 105, the tray forms a seal with the front panel that prevents debris from escaping during the cleaning process. In an alternative embodiment, a small vacuum unit is attached to the burr hog to aid in the removal of debris. A visual inspection means is provided on top 125 of the housing so the user can easily inspect the grooves of dental burrs after removal from the burr hog 100. The preferred inspection means is a magnifying glass 120 that is connected to the device by a hinge 130, however other inspection means, including microscopes and chemical tests, can be provided in other embodiments. A vent is provided on the right side 135 of the device next to the power compartment. A power cord 140 that can be plugged into an electrical outlet is also connected to the power compartment—discussed further below in conjunction with FIG. 4. The dashed arrow with the number 3 next to it, represents the view shown in FIG. 3. The dashed arrow with the number 4 next to it, represents the view shown in FIG. 4.

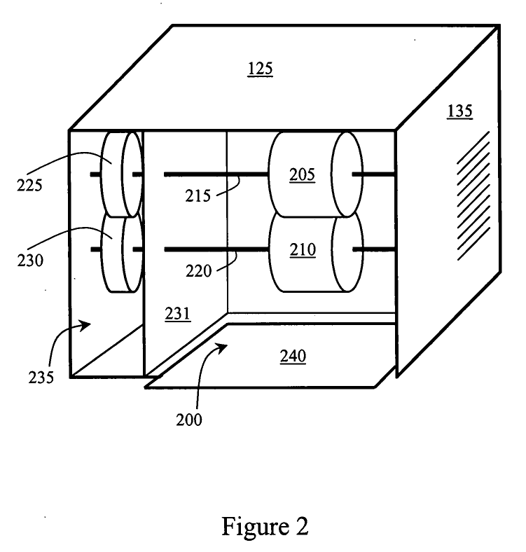

FIG. 2 shows the preferred embodiment 100 with the front panel removed so that the cleaning compartment 200, and part of the gear compartment 235, are shown. The cleaning compartment 200 houses the two circular brushes 205 & 210 that are used to clean the dental burrs, and a cleaning tray 240 that collects the debris from the dental burrs. Each circular brush 205 & 210 is preferably made of steel bristles and the bristles are small enough to fit within the grooves on the dental burr. Steel bristles are preferred because the bristles can be provided with the required, small diameter, and still have enough strength to physically brush the un-wanted material from the grooves of dental burrs. The brushes in the present burr hog 100 can also be removed after so many cleanings and replaced with new brushes. The two circular brushes 205 & 210 are positioned one on top of the other and rotate in opposite directions. When a dental burr is inserted into the burr hog, the dental burr is guided in between the two circulating brushes 205 & 210 and the user feels a slight pull on the cleaning rod as the brushes engage the burr. The top brush 205 scours the top of the burr and the bottom brush 210 scours the bottom of the burr. By slowly rotating the burr, via the cleaning rod, while the burr is inserted in the burr hog, the user will insure that all surfaces of the dental burr, including the grooves, receive a good cleaning. The user may also incorporate a slight in and out motion to insure the top and bottom portions the dental burr are scoured by the rotating brushes. An up or down movement of the holding rod during cleaning will increase the friction between the bottom or top, respectively, of the burr and one of the circular brushes 205 & 210. This up and down movement enhances the cleaning ability of the present burr hog and can be used to remove extremely stubborn materials, such as rust. The back wall of the cleaning compartment is positioned at a distance behind the brushes so that it acts as a “stop” for the inserted dental burr, wherein the “stop” allows a dental burr to be pushed just past the two brushes, but no further. Thus, the user does not have to be afraid of inserting the dental burr too far into the present cleaning device. Moreover, the burr hog will not be able to pull the dental burr, and holding rod, out of the user's hand after the burr engages the rotating brushes. A protrusion from the back wall of the cleaning compartment can be provided and used as the “stop”, if needed, because of the size of the brushes.

The top brush 205 in the cleaning compartment is supported by, and connected to, a top axle 215. The top gear 225 in the gearing system is also supported by, and connected to, the top axle 215. Thus, when top gear 225 is turned, the upper axle 215 turns and the top brush 205 rotates. The bottom brush 210 is supported by, and connected to, a bottom axle 220. The bottom gear 230 in the gearing system is also supported by, and connected to, the bottom axle 220. When the bottom gear 230 is turned, the bottom axle 220 turns and the bottom brush 210 rotates. The gear compartment 235 is separated from the cleaning compartment 200 by a support wall 231. The support wall 231 helps keep all debris from the dental burrs in the cleaning compartment 200, and importantly prevents the debris from entering the gear compartment 235 and causing any problems with the gears. The complete gearing system is shown in FIG. 3.

FIG. 3 shows the left side of the preferred embodiment with the left side of the exterior shell removed so the gearing compartment 235 can be seen. Rotational power is provided by a drive gear 305 that is attached to the drive shaft 315 of an electric motor. The electric motor is housed within a power compartment (shown in FIG. 4) and the drive shaft of the motor extends through support wall 231 and into the gearing compartment 235. Drive gear 305 is mechanically connected to reduction gear 300. Reduction gear 300 is mechanically connected to bottom gear 230. And, bottom gear 230 is mechanically connected to top gear 225. This gearing arrangement allows the top and bottom gears 225 & 230 to rotate in opposite directions, which is needed for smooth and efficient operation of the two rotating brushes. The gears have been illustrated without teeth for simplicity sake and while the same gearing arrangement could be produced with friction wheels, the preferred embodiment includes gears with teeth. The reduction gear 300 is supported by reduction gear axle 310. As mentioned above, top gear 225 is supported by top axle 215, and bottom gear 230 is supported by bottom axle 220. Of course, other drive systems may also be used in other embodiments of the present cleaning device. For example, more or less gears could be used, gears of different sizes could be used, bushings could be used instead of bearings, and more than one electric motor could be used.

FIG. 4 shows the back of the preferred embodiment with the back of the exterior shell removed so the power compartment 400 can be seen. The power compartment 400 includes an electric motor 405, a battery pack 415, power circuitry 420 and a power cord 140. The drive shaft 315 of the electric motor 405 extends through support wall 231 and into the gearing compartment 235. The battery pack 415 is preferably removable and rechargeable. The battery pack 415 automatically provides power to the electric motor 405 when the power cord 140 is not plugged into an electrical outlet. The battery pack 415 makes the present Burr Hog extremely portable and allows it to be used anywhere, without the restriction of having to be located close to an electrical outlet.

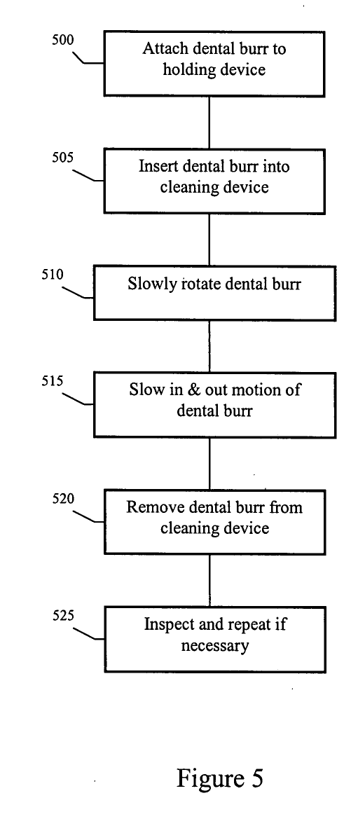

FIG. 5 is a flow chart showing exemplary steps for using the preferred embodiment. In step 500, a dirty dental burr is attached to a holding device. The holding device can be a rod with the same attachment mechanism as a dental drill, a hemostat, or other holding device. In step 505, the dental burr is inserted through the stretchable, insertion hole in the front of the Burr Hog. The brushes of the burr hog automatically start rotating upon insertion of the dental burr. In step 510, the user slowly rotates the dental burr, via the holding device, while the burr is being held between the two rotating brushes. This motion insures that all sides of the burr engage with the brushes during the cleaning process. This motion also insures the grooves of burrs with diagonal grooves that wind around the burr will be thoroughly cleaned. The user will know when the dental burr is between the rotating brushes, as he will feel a slight pull on the holding device. In step 515, the cleaning technician uses an “in and out” motion to insure the top and bottom of the dental burr engage with the rotating brushes and are scrubbed cleaned. The “stop” that is provided in the back of the cleaning compartment lets the user know when the burr is all the way “in” by blocking any further insertion. The user will know when the burr is effectively “out” of the brushes as he will no longer feel any pull on the holding device. In step 520, the user completely removes the dental burr from the Burr Hog, and the device automatically shuts off. In step 525, the operator uses the magnifying glass to inspect the top, bottom, sides and grooves of the dental burr, and any of the above steps that need repeating are repeated. Of course, more or less steps than those listed above could be used in the cleaning of different dental burrs. For example, an extremely dirty burr could require the additional step of moving the holding device up and down so that higher amounts of friction are used to clean the burr. Also, the above exemplary cleaning steps could be executed in a different order.

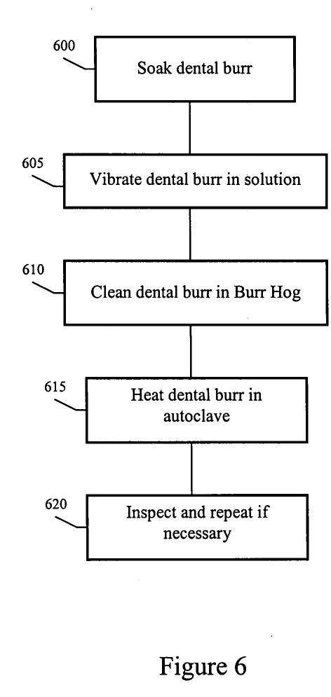

FIG. 6 is a flow chart showing exemplary steps for cleaning and sanitizing dental burrs. The present invention is excellent at removing amalgam, resin and composite materials from the grooves of dental burrs. However, the inventors realize that to provide a truly sanitized dental bur, the burr hog should be used in combination with other cleaning and sanitizing methods. FIG. 6 lists exemplary cleaning methods that can be used in combination with the present burr hog to provide a sanitized dental burr. In step 600, the dental burr is soaked in a solution, such as an enzymatic solution that attacks the particles attached to the burr. In step 605, the dental burr is vibrated while in a solution, via ultra-sound for example. In step 610, the dental burr is cleaned in the present burr hog, using one or more of the steps shown in FIG. 5. In step 615, the dental burr is heated in an autoclave to kill any remaining microscopic organisms. In step 620, the dental burr is inspected, and any of the above steps that need repeating are repeated. Of course, more or less steps than those listed above could be used to sanitize dental burrs. For example, a power wash step could also be added, or a step could be removed. Also, the above exemplary sanitizing steps could be executed in a different order than that listed above.

The foregoing description of the specific embodiments will so fully reveal the general nature of the invention that others can, by applying current knowledge, readily modify and/or adapt for various applications such specific embodiments without departing from the generic concept. For example, the present cleaning device could be provided wherein the stretchable insertion hole is provided on the top of the housing, instead of on the side. Further, a direct drive Burr Hog could be provided wherein the circular brushes are directly connected to motors and no gears are required. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. A automated device that is adapted for cleaning dental drill bits, the device comprising:
a cleaning compartment, the cleaning compartment housing at least one brush, supported by a first axle, wherein the first axle is attached to the at least one brush so that the brush rotates when the axle is rotated;
a power compartment, the power compartment housing at least one electric motor with a drive shaft that provides rotational force for the at least one brush, wherein the power compartment is adapted for electrical connection to a power source; and,
an exterior shell that houses the cleaning compartment and the power compartment, wherein the exterior shell allows access to the cleaning compartment in such a way that debris that is removed from the drill bit during cleaning is contained within the cleaning compartment.

2. The device of claim 1, wherein the at least one brush in the cleaning compartment is a circular brush and the cleaning compartment further comprises a second circular brush, wherein the second circular brush is supported by a second axle so that the second circular brush rotates when the second axle is rotated.

3. The device of claim 2, further comprising:
a gear compartment, the gear compartment housing a series of gears that transfers the rotational force from the drive shaft to the first and second axles, wherein the gear compartment is housed within the exterior shell.

4. The device of claim 1, further comprising:
a debris tray, the debris tray being housed at a bottom of the cleaning compartment and adapted for catching debris that is scoured from the drill bit during cleaning, wherein the debris tray can be removed and emptied via a horizontal opening in the exterior shell.

5. The device of claim 1, further comprising:
an inspection assistance device that is attached to the exterior shell, wherein the inspection assistance device aids a user while inspecting the drill bit after cleaning.

6. The device of claim 1, wherein the exterior shell includes at least one opening that leads into the cleaning compartment, the at least one opening being adapted to allow passage there-through of a drill bit and a cleaning rod, wherein the drill bit contacts the at least one brush after passing through the opening.

7. The device of claim 3, wherein the series of gears comprises four gears: a drive gear attached to the drive shaft; a first brush gear attached to the first axle; a second brush gear attached to the second axle; and, a reduction gear that is supported by a support axle.

8. The device of claim 7, wherein the drive gear engages with the reduction gear, the reduction gear engages with the second brush gear, and the second brush gear engages with the first brush gear.

9. The device of claim 7, wherein the first brush gear and the second brush gear have a same size.

10. The device of claim 2, wherein the first and second circular brushes have a width that is more than 0.25 inches and less than 3.0 inches.

11. The device of claim 1, wherein the power compartment further comprises a battery pack that is electrically connected to the electric motor.

12. The device of claim 1, wherein the exterior shell has a cube shape and the at least one small opening in the shell is circular in shape.

13. A method for cleaning and sterilizing dental drill bits involving the use of a cleaning device with at least one rotating brush that is powered by an electric motor, the method comprising the steps of:
attaching a dental drill bit to a cleaning rod;
inserting the drill bit and cleaning rod through an opening in the cleaning device, so that the drill bit contacts the at least one rotating brush;
slowly rotating the cleaning rod while the drill bit is in contact with the at least one rotating brush;
removing the cleaning rod and drill bit from the cleaning device.

14. The method of claim 13, further comprising the step of:
inspecting the drill bit and repeating the steps of inserting, slowly rotating, and removing, if necessary.

15. The method of claim 13, wherein the step of removing is preceded by the step of:
slowly moving the drill bit and cleaning rod in and out of the cleaning device.

16. The method of claim 13, wherein the step of attaching is preceded by the step of:
soaking the drill bit in a cleaning solution.

17. The method of claim 16, wherein the step of soaking is followed by the step of:
vibrating the drill bit in the solution.

18. The method of claim 13, wherein the step of removing is followed by the step of:
heating the drill bit in autoclave.
